(19) United States
(12) Patent Application Publication
(10) Pub. No.: US 2026/0030561 A1
(43) Pub. Date: Jan. 29, 2026

(54) SYSTEM AND METHOD FOR PERFORMING AIRLINE AGNOSTIC CABIN CLASS MAPPING

(71) Applicant: AIRLINES REPORTING CORPORATION, Arlington, VA (US)

(72) Inventors: Shitalkumar Sarangdharrao SABNE, Aldie, VA (US); Steven BOTHAM, Plant City, FL (US); Nicholas Alexander GARE, Brandon, FL (US)

(73) Assignee: AIRLINES REPORTING CORPORATION, Arlington, VA (US)

(21) Appl. No.: 18/781,198

(22) Filed: Jul. 23, 2024

(51) Int. Cl. G06Q 10/02; G06F 18/23213

(52) U.S. Cl. CPC G06Q 10/02; G06F 18/23213

(57) ABSTRACT

A method and system for providing an airline agnostic dynamic cabin mapping are disclosed. The method includes gathering raw data from one or more data sources for capturing reservation booking designator (RBKD) values for various airlines and executing a fare mapping algorithm for generating a fare type variable. The method further includes compiling the raw data gathered and the fare type variable for generating unlabeled data set, and performing dimensionality reduction on the unlabeled data set for generating a set of input variables to input to a machine learning (ML) model. The ML model is then executed for generating cabin class clusters by inputting the set of input variables, creating percentile-based references to assign class service names for each of the cabin class clusters, and displaying a graphical representation of cabin class mapping for the various airlines based on the percentile-based references.

### TECHNICAL FIELD

This disclosure generally relates to a machine-learning driven mapping for providing a more accurate and more up-to-date airline agnostic cabin class mapping. More specifically, the present disclosure generally relates to a system and method for providing a dynamic cabin mapping based on various carriers, routes and fare types without proprietary airline specific mapping information.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Conventionally, each airline may provide its own respective ticket designator code for a given airline ticket. Moreover, every airline utilizes reservation ticket designator for each fare ladder differently. Fare ladder may refer to a breakdown of destinations, airfare, taxes and surcharges, which may appear on an airline ticket. Accordingly, it is difficult to capture cabin class mapping on a timely basis along with fare ladder changes for various airlines contemporaneously.

### SUMMARY

According to an aspect of the present disclosure, a method for providing an airline agnostic dynamic cabin mapping is provided. The method includes gathering, by a processor, raw data from one or more data sources for capturing reservation booking designator (RBKD) values for a plurality of airlines; determining, by the processor, airline data participation for each of the plurality of airlines, wherein the airline data participation is direct or indirect; executing, by the processor, a fare mapping algorithm for generating a fare type variable based on the raw data gathered; compiling, by the processor, the raw data gathered and the fare type variable for generating unlabeled data set; performing, by the processor, dimensionality reduction on the unlabeled data set for generating a set of input variables to input to a machine learning (ML) model; executing, by the processor, the ML model for generating a plurality of cabin class clusters by inputting the set of input variables; creating, by the processor, percentile-based references to assign class service names for each of the plurality of cabin class clusters; and displaying, on a display, a graphical representation of cabin class mapping for each of the plurality of airlines based on the percentile-based references.

According to another aspect of the present disclosure, the ML model is an unsupervised K-means algorithm model.

According to another aspect of the present disclosure, the percentile-based references map the RBKD values of each of the plurality of airlines to a cluster value and a corresponding cabin class cluster.

According to yet another aspect of the present disclosure, the cabin class cluster indicates a cabin class, the cabin class being at least one of a first class, business class, economy class, premium economy class, and discount economy class.

According to another aspect of the present disclosure, the percentile-based references further map airline identifiers to the RBKD values of the plurality of airlines.

According to a further aspect of the present disclosure, the fare type variable indicates a fare type.

According to yet another aspect of the present disclosure, the fare type corresponds to a plurality of RBKD values.

According to a further aspect of the present disclosure, the fare type corresponds to a single RBKD value.

According to another aspect of the present disclosure, the fare mapping algorithm utilizes association rules from the raw data gathered.

According to a further aspect of the present disclosure, when the airline data participation of an airline among the plurality of airlines is determined to be direct, the one or more data sources includes the airline.

According to a further aspect of the present disclosure, the dimensionality reduction is performed using correlation analysis.

According to a further aspect of the present disclosure, the dimensionality reduction is further performed based on at least one of a factor analysis, correlation analysis, feature importance ratio technique.

According to a further aspect of the present disclosure, the method includes creating a first training set comprising a mapping between the RKBD values and the cabin class clusters; training the ML model in a first stage using the first training set; creating a second training set comprising the first training set and a portion of the mapping between the RKBD values and the cabin class clusters that are incorrectly determined after the first stage of training; and training the ML model in a second stage using the second training set.

According to a further aspect of the present disclosure, the raw data gathered includes at least a carrier number, the RBKD values, total ticketing amount, average fare, and average tax amount.

According to a further aspect of the present disclosure, the raw data includes data elements listed on an airline ticket.

According to a further aspect of the present disclosure, the RBKD values are included in fare basis codes.

According to a further aspect of the present disclosure, the cabin class mapping is displayed as a color-coded graph in the graphical representation.

According to a further aspect of the present disclosure, each ticket is displayed as a node of a particular color corresponding to a respective cabin class.

According to an aspect of the present disclosure, a system for providing an airline agnostic dynamic cabin mapping is provided. The system includes a memory, a display and a processor. The system is configured to perform: gathering raw data from one or more data sources for capturing reservation booking designator (RBKD) values for a plurality of airlines; determining airline data participation for each of the plurality of airlines, wherein the airline data participation is direct or indirect; executing a fare mapping algorithm for generating a fare type variable based on the raw data gathered; compiling the raw data gathered and the fare type variable for generating unlabeled data set; performing dimensionality reduction on the unlabeled data set for generating a set of input variables to input to a machine learning (ML) model; executing the ML model for generating a plurality of cabin class clusters by inputting the set of input variables; creating percentile-based references to assign class service names for each of the plurality of cabin class clusters; and displaying, on the display, a graphical representation of cabin class mapping for each of the plurality of airlines based on the percentile-based references.

According to another aspect of the present disclosure, a method for providing an airline agnostic dynamic cabin mapping is provided. The method includes gathering raw data from one or more data sources for capturing reservation booking designator (RBKD) values for a plurality of airlines; determining airline data participation for each of the plurality of airlines, wherein the airline data participation is direct or indirect; executing a fare mapping algorithm for generating a fare type variable based on the raw data gathered; compiling the raw data gathered and the fare type variable for generating unlabeled data set; performing dimensionality reduction on the unlabeled data set for generating a set of input variables to input to a machine learning (ML) model; executing the ML model for generating a plurality of cabin class clusters by inputting the set of input variables; creating percentile-based references to assign class service names for each of the plurality of cabin class clusters; and displaying, on a display, a graphical representation of cabin class mapping for each of the plurality of airlines based on the percentile-based references.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a cabin class mapping system in accordance with an exemplary embodiment.

FIG. 2 illustrates a diagram of a network environment with a cabin class mapping system in accordance with an exemplary embodiment.

FIG. 3 illustrates a system diagram for implementing a cabin class mapping system in accordance with an exemplary embodiment.

FIG. 4 illustrates a method for identifying a class of service of tickets based on different designator codes for various travel tickets of differing airlines in accordance with an exemplary embodiment.

FIG. 5 illustrate a system diagram for identifying a class of service of tickets based on different designator codes for various travel tickets of differing airlines in accordance with another exemplary embodiment.

FIG. 6 illustrates grouping of reservation booking designator codes according to fare types based on association rules in accordance with an exemplary embodiment.

FIG. 7 illustrates compilation of various raw ticketing data elements and generated data variables into unlabeled data set in accordance with an exemplary embodiment.

FIG. 8 illustrates percentile-based references for cluster groups in accordance with an exemplary embodiment.

FIG. 9 illustrates graphs of cabin class mapping results in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

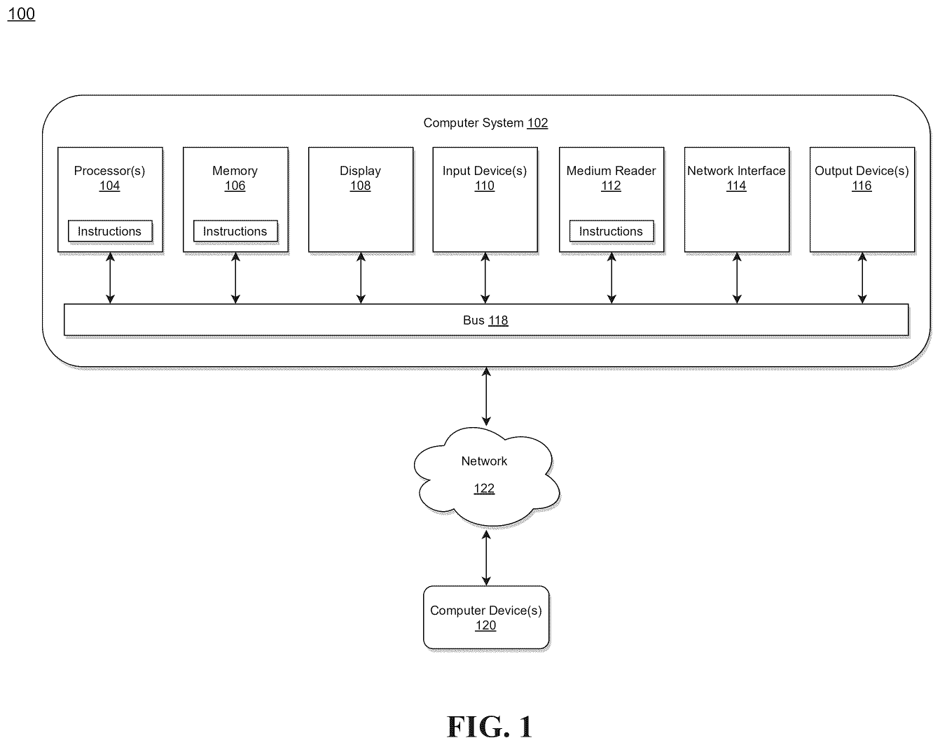

FIG. 1 illustrates a computer system for implementing a cabin class mapping system in accordance with an exemplary embodiment.

The system 100 is generally shown and may include a computer system 102, which is generally indicated. The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The network interface 114 may include, without limitation, a communication circuit, a transmitter or a receiver. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, or the like.

The computer system 102 may be in communication with one or more additional computer devices 120 via a network 122. The network 122 may be, but is not limited thereto, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

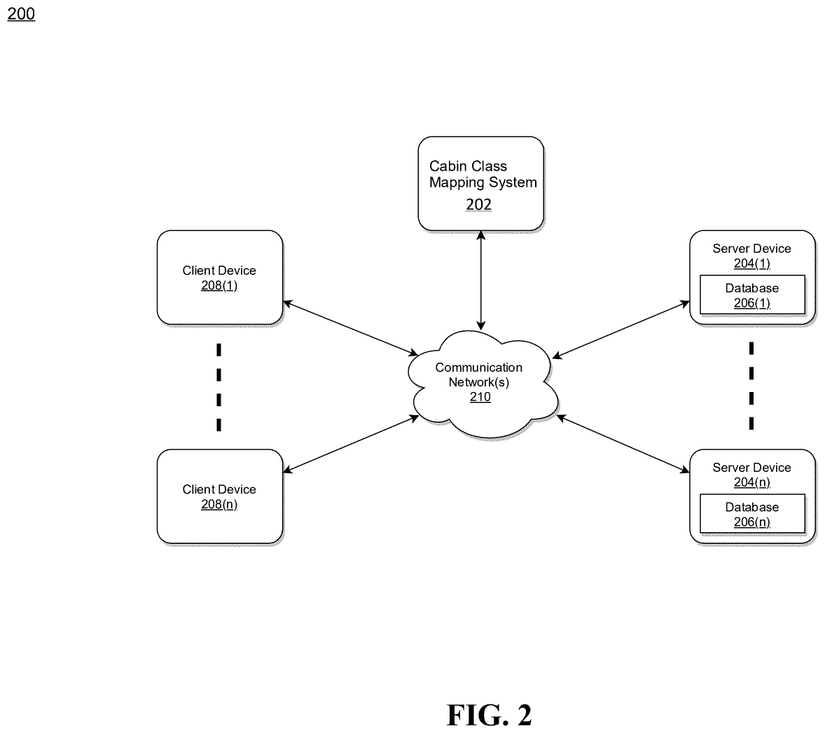

FIG. 2 illustrates a diagram of a network environment with a cabin class mapping system in accordance with an exemplary embodiment.

A cabin class mapping system 202 may be implemented with one or more computer systems similar to the computer system 102 as described with respect to FIG. 1.

The cabin class mapping system 202 may store one or more applications that can include executable instructions that, when executed by the cabin class mapping system 202, cause the cabin class mapping system 202 to perform actions, such as to execute, transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment or other networking environments. The application(s) may be executed within or as virtual machine(s) or virtual server(s) that may be managed in a cloud-based computing environment. Also, the application(s), and even the cabin class mapping system 202 itself, may be located in virtual server(s) running in a cloud-based computing environment rather than being tied to one or more specific physical network computing devices. Also, the application(s) may be running in one or more virtual machines (VMs) executing on the cabin class mapping system 202. Additionally, in one or more embodiments of this technology, virtual machine(s) running on the cabin class mapping system 202 may be managed or supervised by a hypervisor.

In the network environment 200 of FIG. 2, the cabin class mapping system 202 is coupled to a plurality of server devices 204(1)-204(n) that hosts a plurality of databases 206(1)-206(n), and also to a plurality of client devices 208(1)-208(n) via communication network(s) 210. According to exemplary aspects, databases 206(1)-206(n) may be configured to store data that relates to distributed ledgers, blockchains, user account identifiers, biller account identifiers, and payment provider identifiers. A communication interface of the cabin class mapping system 202, such as the network interface 114 of the computer system 102 of FIG. 1, operatively couples and communicates between the cabin class mapping system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the cabin class mapping system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The cabin class mapping system 202 may be a standalone device or integrated with one or more other devices or apparatuses, such as one or more of the server devices 204(1)-204(n), for example. In one particular example, the cabin class mapping system 202 may be hosted by one of the server devices 204(1)-204(n), and other arrangements are also possible. Moreover, one or more of the devices of the cabin class mapping system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the cabin class mapping system 202 via the communication network(s) 210 according to the HTTP-based protocol, for example, although other protocols may also be used. According to a further aspect of the present disclosure, in which the user interface may be a Hypertext Transfer Protocol (HTTP) web interface, but the disclosure is not limited thereto.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the cabin class mapping system 202 that may efficiently provide a platform for implementing a cloud native cabin class mapping system module, but the disclosure is not limited thereto.

The client devices 208(1)-208(n) may run interface applications, such as standard web browsers or standalone client applications, which may provide an interface to communicate with the cabin class mapping system 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the cabin class mapping system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the cabin class mapping system 202, the server devices 204(1)-204(n), or the client devices 208(1)-208(n), for example, may be configured to operate as virtual instances on the same physical machine. For example, one or more of the cabin class mapping system 202, the server devices 204(1)-204(n), or the client devices 208(1)-208(n) may operate on the same physical device rather than as separate devices communicating through communication network(s) 210. Additionally, there may be more or fewer cabin class mapping systems 202, server devices 204(1)-204(n), or client devices 208(1)-208(n) than illustrated in FIG. 2. According to exemplary embodiments, the cabin class mapping system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

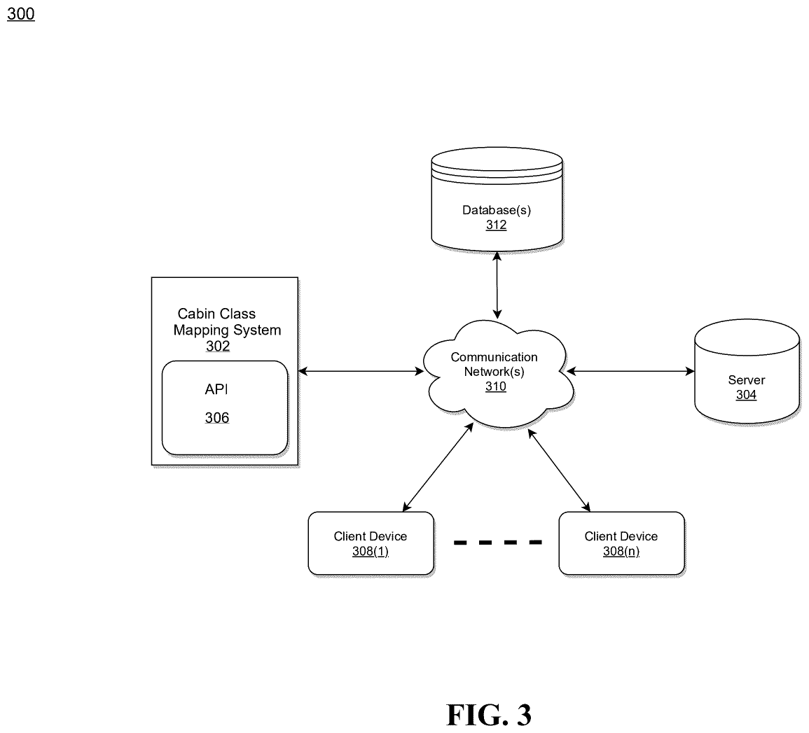

FIG. 3 illustrates a system diagram for implementing a cabin class mapping system in accordance with an exemplary embodiment.

As illustrated in FIG. 3, the system 300 may include a cabin class mapping system 302 within which a group of API modules 306 is embedded, a server 304, a database(s) 312, a plurality of client devices 308(1) . . . 308(n), and a communication network 310.

According to exemplary embodiments, the cabin class mapping system 302 including the API modules 306 may be connected to the server 304, and the database(s) 312 via the communication network 310. Although there is only one database that has been illustrated, the disclosure is not limited thereto. Any number of databases may be utilized. The cabin class mapping system 302 may also be connected to the plurality of client devices 308(1) . . . 308(n) via the communication network 310, but the disclosure is not limited thereto.

According to exemplary embodiment, the cabin class mapping system 302 is described and shown in FIG. 3 as including the API modules 306, although it may include other rules, policies, modules, databases, or applications, for example. According to exemplary embodiments, the database(s) 312 may be embedded within the cabin class mapping system 302. According to exemplary embodiments, the database(s) 312 may be configured to store configuration details data corresponding to a desired data to be fetched from one or more data sources, but the disclosure is not limited thereto.

According to exemplary embodiments, the API modules 306 may be configured to receive real-time feed of data or data at predetermined intervals from the plurality of client devices 308(1) . . . 308(n) via the communication network 310.

The API modules 306 may be configured to implement a user interface (UI) platform that is configured to enable cabin class mapping system as a service for a desired data processing scheme. The UI platform may include an input interface layer and an output interface layer. The input interface layer may request preset input fields to be provided by a user in accordance with a selection of an automation template. The UI platform may receive user input, via the input interface layer, of configuration details data corresponding to a desired data to be fetched from one or more data sources. The user may specify, for example, data sources, parameters, destinations, rules, and the like. The UI platform may further fetch the desired data from said one or more data sources based on the configuration details data to be utilized for the desired data processing scheme, automatically implement a transformation algorithm on the desired data corresponding to the configuration details data and the desired data processing scheme to output a transformed data in a predefined format, and transmit, via the output interface layer, the transformed data to downstream applications or systems.

The plurality of client devices 308(1) . . . 308(n) are illustrated as being in communication with the cabin class mapping system 302. In this regard, the plurality of client devices 308(1) . . . 308(n) may be “clients” of the cabin class mapping system 302 and are described herein as such. Nevertheless, it is to be known and understood that the plurality of client devices 308(1) . . . 308(n) need not necessarily be “clients” of the cabin class mapping system 302, or any entity described in association therewith herein. Any additional or alternative relationship may exist between either or both of the plurality of client devices 308(1) . . . 308(n) and the cabin class mapping system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the cabin class mapping system 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The cabin class mapping system 302 may be the same or similar to the cabin class mapping system 202 as described with respect to FIG. 2, including any features or combination of features described with respect thereto.

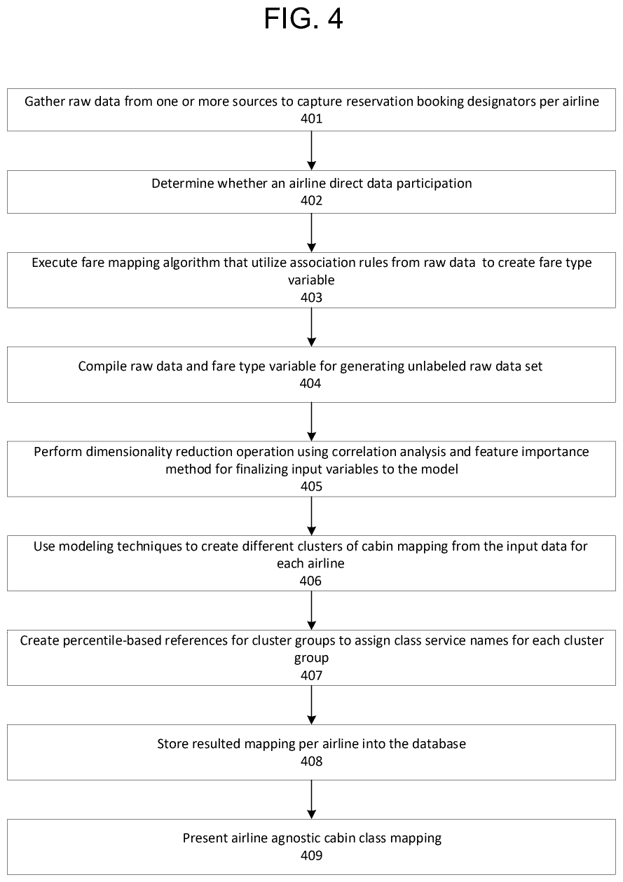

FIG. 4 illustrates a method for identifying a class of service of tickets based on different designator codes for various travel tickets of differing airlines in accordance with an exemplary embodiment.

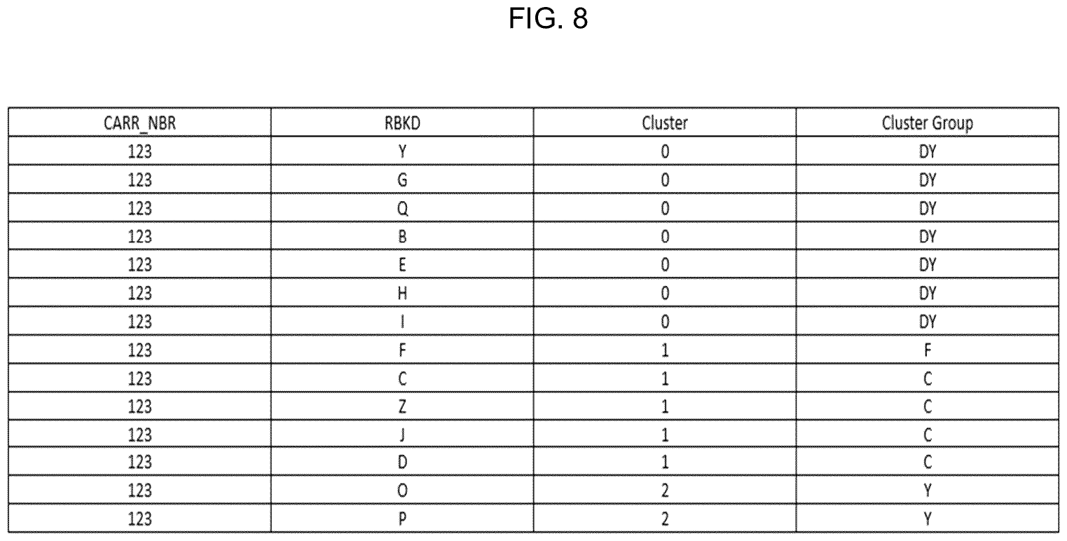

According to exemplary aspects, a cabin class mapping system may provide a machine learning driven output, which may provide users with the most accurate and up-to-date cabin mapping information based on one or more of carriers, routes, fare types and the like. Unlike conventional systems, the cabin class mapping system may utilize machine learning processes to identify cabin mapping for carriers, even when each carrier may utilize different codes or mechanisms for designating cabin class. According to exemplary aspects, each segment reservation booking designator code (RBKD) may be grouped into a cluster, and mapped to a respective cabin class in real-time. In an example, RBKD values may correspond to a cabin class and may be unique for differing airlines. However, RBKD may be undecipherable without airline specific mapping information, which may be proprietary to individual airlines. The RBKD value may be indicated by a single letter. For example, RBKD values of Y, G, Q, B, E, H, I, F, C, Z, J, D, O, and P are displayed on FIG. 8.

A cabin class may refer to a specific grouping of seats arranged on an aircraft, which are typically located at different portions of the aircraft. In an example, cabin class includes first class (F), business class (C), economy (Y), discount economy (DY) and all others (AO). According to exemplary aspects, the economy class may include premium economy. However, aspects of the present disclosure are not limited thereto, such that the premium economy may be designated as a separate cabin class. Moreover, there may be more or less cabin classes than those listed above.

In operation 401, obtain raw ticketing data elements from various sources. According to exemplary aspects, the various sources may include airlines, travel agencies, third party data sources or the like. Although present disclosure is provided with respect to airlines, aspects of the present disclosure are not limited thereto, such that the disclosure may apply to rail operators, bus operators, ship operators and/or combination thereof. In an example, raw ticketing data elements may include, without limitation carrier number, RBKD, total ticketing amount, fare, average fare, average tax amount, surcharges, origin, destination, and the like.

In operation 402, a determination of whether each of the airlines contribute its data directly or not. When an airline contributes its data directly, respective data may be provided directly from the respective airline, such that the airline itself is the data source from which the raw data is received. However, when an airline does not contribute its data directly, the respective airline data may be captured indirectly, such as via third party or published reports. According to exemplary aspects, indirectly captured data may include less information than the directly captured data. Moreover, in the indirectly captured data, one or more data variables or data points may be generated based on available data.

In operation 403, fare type algorithm is executed to introduce one or more new variables based on association rule method using fare basis code patterns. According to exemplary aspects, the new variables may be generated for further improving accuracy and capture clustering of booking designators between certain cabin classes, such as between premium economy and economy. In an example, the new variable may be a fare type variable. For example, a fare type may be normal fares or special fares. Normal fares may be available for all classes of service and are flexible, whereas special fares may be limited to certain classes of services and may have one or more restrictions. Moreover, one or more association rules may be made by searching data for frequent pattern, such as if-then patterns, and by using reference confidence levels. However, aspects of the present disclosure are not limited thereto, such that the pattern may not be limited to the if-then patterns.

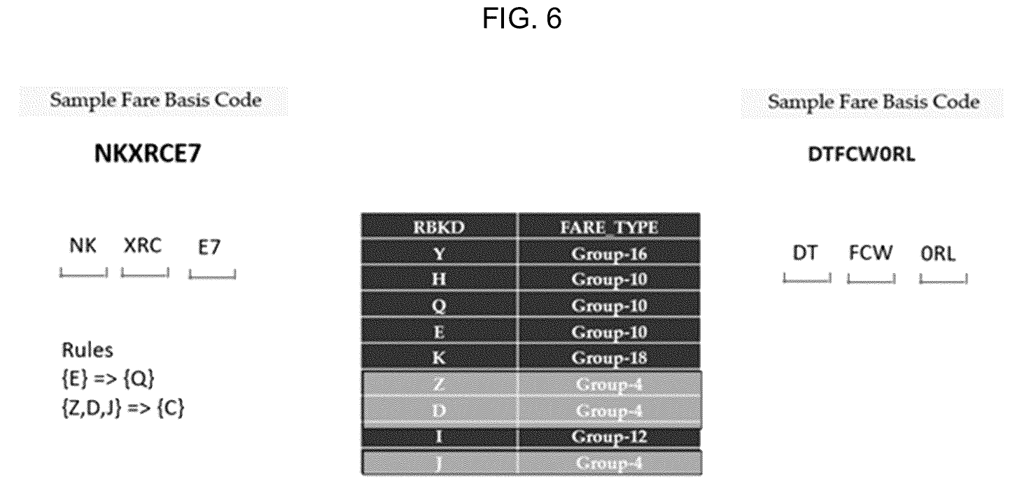

In an example, sample fare basis code may be presented as NKXRCE7 and DTFCW0RL as illustrated in FIG. 6. The fare basis code may be parsed into multiple subsets. According to exemplary aspects, a fare basis code may refer to an alphanumeric code used by various airlines to identify a fare type and applicable rules to the respective fare. However, the fare basis code utilized by airlines may be proprietary and may be different from one airline to another. Accordingly, individuals outside of a target airline may be unable to decipher or interpret the proprietary fare basis code. However, based on a fare basis code patterns, a third party may identify fare types corresponding to the fare basis codes utilized across various airlines.

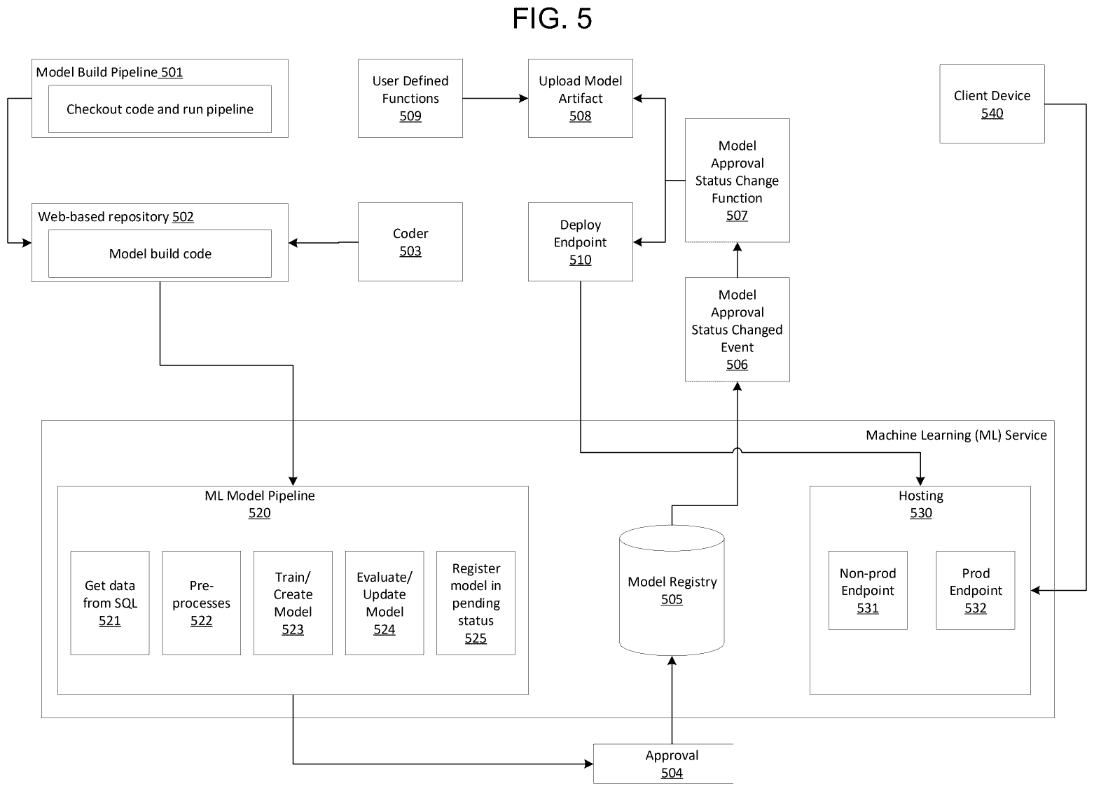

For example, the fare basis code of NKXRCE7 may be parsed into “NK”, “XRC” and “E7”. The fare basis code of DTFCW0RL may be parsed into “DT”, “FCW” and “0RL”. Based on patterns of such parsed subsets of fare basis codes, certain values or subsets may be associated with certain fare types. Moreover, as exemplarily illustrated in FIG. 5A, RBKD values of Z, D and J may be designated to fare type Group-4. Similarly, RBKD values of H, Q and E may be designated to fare type Group-10. On the other hand, RBKD value of I alone may be designated to fare type Group-12.

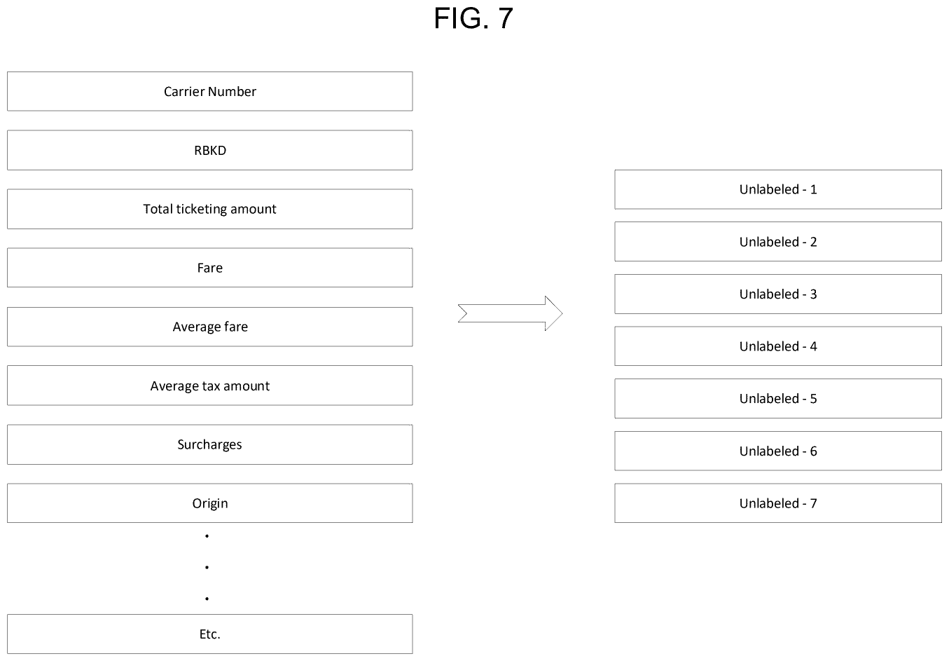

In operation 404 all of the obtained raw ticketing data elements are then compiled into unlabeled data set, as illustrated in FIG. 7, including newly created fare type variables. According to exemplary aspects, unlabeled data sets may refer to data sets that lack specific identifiers, tags or labels that indicate their characteristics or qualities.

In operation 405, dimensionality reduction is performed. According to exemplary aspects, the dimensionality reduction may be performed using one or more analysis, such as factor analysis, correlation analysis, feature importance ratio techniques and the like. Based on the dimensionality reduction performed in operation 403, only the elements that may be relevant to the potential output may be selectively processed while discarding or ignoring other elements for more efficient utilization of computing resources, such as a central processing unit (CPU) and a memory.

In operation 406, the unlabeled data set is processed via an artificial intelligence (AI) or machine learning (ML) algorithm or model. In example, the machine learning model or algorithm may be unsupervised. According to exemplary aspects, unsupervised ML algorithm may be configured to operate independently to discover various information, such as relationships between data points, and predict an outcome of a new data point. The unsupervised ML algorithm may primarily deal with unlabeled data.

The unsupervised ML algorithm may include K-means clustering. K-means clustering may be used for portioning a dataset into a predefined number of clusters. According to exemplary aspects, K-means may refer to a centroid-based clustering algorithm. The K-means clustering algorithm may calculate a distance between each data point and a centroid to assign to a cluster. Each data point may be assigned to the nearest centroid. More specifically, the K-means clustering may group similar data points, based, for example, based on a relative distance between data points. The K-means clustering may result in identifying K number of groups in the unlabeled data set. Further, the K-means clustering may additionally discover underlying patterns or structures within the data.

However, aspects of the present disclosure are not limited thereto, such that AI or ML algorithms may be generative, in that the AI or ML algorithms may be executed to perform data pattern detection, and to provide an output based on the data pattern detection. More specifically, an output may be provided based on a historical pattern of data, such that with more data or more recent data, more accurate outputs may be provided. Accordingly, the ML or AI models may be constantly updated after a predetermined number of runs or iterations are initially performed to provide initial training. According to exemplary aspects, machine learning may refer to computer algorithms that may improve automatically through use of data. Machine learning algorithm may build an initial model based on sample or training data, which may be iteratively improved upon as additional data are acquired.

More specifically, machine learning/artificial intelligence and pattern recognition may include supervised learning algorithms such as, for example, k-medoids analysis, regression analysis, decision tree analysis, random forest analysis, k-nearest neighbors analysis, logistic regression analysis, N-fold cross-validation analysis, balanced class weight analysis, and the like. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, and the like.

In another exemplary embodiment, the ML or AI model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the ML or AI model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the ML or AI models may be generated using at least one from among an artificial neural network technique, a decision tree technique, a support vector machines technique, a Bayesian network technique, and a genetic algorithms technique.

In operation 407, percentile-based references for cluster groups or cabin class clusters may be created for assigning class service names for each of the predicted clusters. As exemplarily illustrated in FIG. 8, a table showing the percentile-based references may include carrier number (CARR_NBR), RBKD, cluster and corresponding cabin class cluster or cluster group. According to exemplary aspects, the carrier number may be a numerical value that corresponds to a particular airline. RBKD may refer to a singular alphabetical value that corresponds to a particular cabin class. However, the RBKD values may be different from airline to airline and undecipherable without proprietary mapping information that is unavailable to third parties.

The cabin class mapping system provided cluster values determined for the airline specific RBKD values may reference clusters identified by the K-means clustering algorithm. For example, RBKD values of Y, G, Q, B, E, H and I correspond to cluster value of 0. Similarly, RBKD values of F, C, Z, J and D correspond to cluster value of 1, while RBKD values of O and P correspond to cluster value of 2. Cluster group value may indicate a specific cabin class value for a cluster value. Cluster group may include first class (F), business class (C), economy (Y), discount economy (DY) and the like. Cluster value of 0 corresponds to the cluster group value of DY, while cluster values of 1 and 2 correspond to cluster groups of C and Y, respectively.

Accordingly, based on the percentile-based references, airline agnostic cabin class identifications may be determined and aggregated for multiple airlines even when those airlines individually utilize their respective proprietary fare basis codes.

In operation 408, outputs provided by the unsupervised ML algorithm is stored and posted. According to exemplary aspects, the outputs may include clustering predictions, in which each cluster may correspond to at least one cabin class.

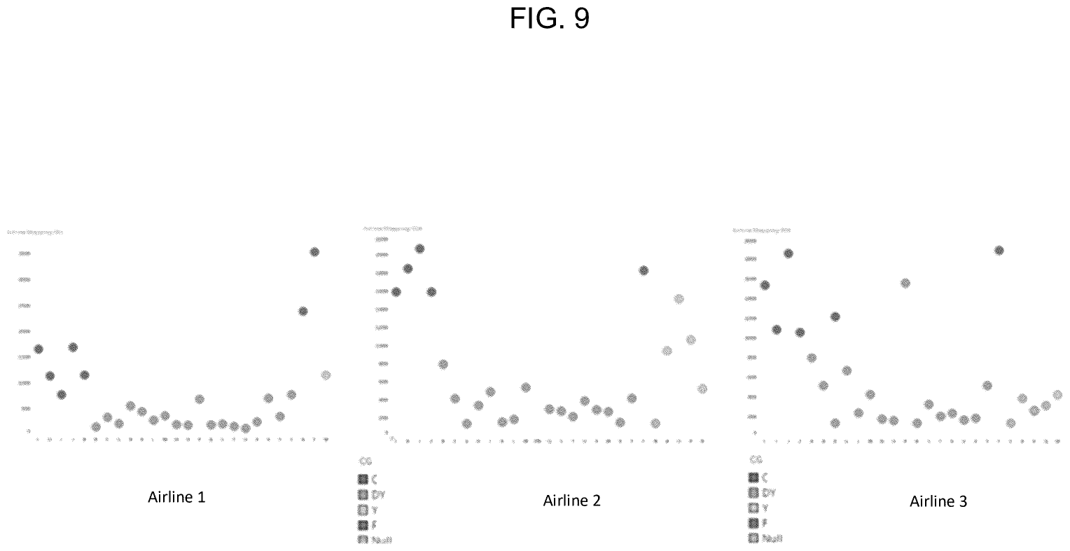

In operation 409, the airline agnostic cabin class mappings may be presented on a display. According to exemplary aspects, the aggregated airline agnostic cabin class mappings may be presented for each of the airlines as a graphic representation as exemplarily illustrated in FIG. 9. The graphic representation may include various data points or nodes corresponding to tickets, and each of the data points or nodes may be color coded to reflect a certain cabin class. Moreover, the graphic representation may be modified or configurable based on user input or filtering via a user interface. However, aspects of the present disclosure are not limited thereto, such that the cabin class mappings may be presented in an aggregate.

As exemplarily described above, the above noted method provides an autonomous process for identifying and assigning fare cabin class to booking designator based on air ticketing data without explicitly using or requiring airline published fare mappings, which may be unavailable to external parties. Based on the airline agnostic cabin class mapping, personalized communications may be provided to passengers in view of corresponding class mapping information rather than providing a non-specific generic information.

FIG. 5 illustrate a system diagram for identifying a class of service of tickets based on different designator codes for various travel tickets of differing airlines in accordance with another exemplary embodiment.

According to exemplary aspects, one of more ML algorithm models may be generated, trained, evaluated and updated for performing an airline agnostic cabin class mapping operation. The model build pipeline 501 may initiate the process by checking out a base code and running the pipeline. The web-based repository 502 may receive additional code from a coder 503 and begin the model build code process by submitting a model build request to the ML model pipeline 520.

The ML model pipeline 520 performs at least one iteration of operation 521 (get data from SQL), operation 522 (pre-processes), operation 523 (train/create model), operation 524 (evaluate/update model), and operation 525 (register model in pending status). According to exemplary aspects, the ML model pipeline 520 may be a cloud-based machine-learning platform that allows the creation, training and deployment of machine-learning developers of machine-learning models om the cloud.

The operation 521 may obtain data from SQL or other data bases for building and/or training an ML algorithm model. For example, the data obtained may include raw data provided by one or more airlines, including those directed to ticketing information. In operation 522, one or more preprocesses are performed on the raw data obtained. For example, the preprocesses may include, without limitation, compiling of the obtained raw data into unlabeled data set, generating of additional data elements, parsing of raw data and the like. Once the requisite preprocesses are performed, a first training data set is prepared and utilized to train a base ML algorithm model in operation 523 for generating a first trained ML algorithm model.

Upon generating the first stage trained ML algorithm model, operation 524 is performed to evaluate the accuracy of the first trained ML algorithm model. In an example, the evaluation process may include identification of correctly identified cabin class mapping and incorrectly identified cabin class mapping.

Based on the evaluation, operation 523 is performed again to generate a second training data set for performing a second stage of training. In an example, the second training data set includes the first training data set and incorrectly detected or identified class cabin mapping between RBKD values and cabin class clusters after the first stage of training. The second trained ML algorithm model may then be evaluated again in operation 524.

If the second trained ML algorithm model is determined to be satisfactory, then the second trained ML algorithm model may be set in pending status in operation 525. Alternatively, if the second stage trained ML algorithm model is determined to be unsatisfactory, additional training may be performed. According to exemplary aspects, a trained ML algorithm model may be determined to be satisfactory once a predetermined accuracy threshold is achieved. However, aspects of the present disclosure are not limited thereto, such that at least a reference number of training iterations may be required prior to proceeding to operation 525.

Once the trained ML algorithm model is registered in pending status in operation 525, an approval process may be performed in operation 504. In an example, the approval process in operation 504 may be an automated approval or a manual approval. According to exemplary aspects, a first level of accuracy may trigger an automated approval process, whereas a second level of accuracy that is lower than the first level of accuracy may trigger a manual approval process.

When the trained ML algorithm model receives the necessary approval in operation 504, the trained ML algorithm model is registered and stored in the model registry 505. According to exemplary aspects, the model registry 505 may be a database or a datastore.

Once the trained ML algorithm model is registered and stored in the model registry 505, a model approval status changed event 506 is triggered. In an example, the model approval status changed event 506 may be trigger upon registration of the trained ML algorithm model. The model approval status changed event 506 may indicate that the trained ML algorithm model has been received necessary approval or approvals for deployment.

In response to the triggering of the model approval status changed event 506, the model approval status change function 507 is executed. According to exemplary aspects, the execution of the model approval status change function 507 may trigger two operations, namely operations 508 and 510. In operation 508, the trained ML algorithm model is uploaded to a cloud storage as a data object. In addition, user defined functions 509 may also be uploaded to the cloud storage for integration with the uploaded ML algorithm model. Also, the ML algorithm model is sent to the deploy endpoint 510 for deployment to hosting server or system 530.

In the hosting server or system 530, it may be hosted on one or more of the non-production endpoint 531 or a production endpoint 532. The non-production endpoint 531 may allow access to a testing environment or user acceptance testing environment. In contrast, the production endpoint 532 may allow access to a production environment. The client device 540 may access the hosting server or system 530 to access the trained ML algorithm model in the internal environment via the non-production endpoint 531 or in the production environment via the production endpoint 532.

Further, although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method for providing an airline agnostic dynamic cabin mapping, the method comprising:
gathering, by a processor, raw data from one or more data sources for capturing reservation booking designator (RBKD) values for a plurality of airlines, wherein each of the plurality of airlines utilize a different mechanism for designating a plurality of cabin classes;
determining, by the processor, airline data participation for each of the plurality of airlines, wherein the airline data participation is direct or indirect;
executing, by the processor, a fare mapping algorithm for generating a fare type variable based on the raw data gathered;
compiling, by the processor, the raw data gathered and the fare type variable for generating unlabeled data set;
performing, by the processor, dimensionality reduction on the unlabeled data set for generating a set of input variables to input to a machine learning (ML) model, wherein the ML model is an unsupervised K-means clustering algorithm model that calculates a distance between each data point and a centroid to assign a cabin cluster and assigns each data point to the nearest centroid;
creating a first training set comprising a mapping between the RKBD values and the cabin class clusters;
first training the ML model in a first stage using the first training set;
creating a second training set comprising the first training set and a portion of the mapping between the RKBD values and the cabin class clusters that are incorrectly determined after the first stage of training;
second training the first trained ML model in a second stage using the second training set;
executing, by the processor, the second trained ML model for generating a plurality of cabin class clusters by inputting the set of input variables and partitioning the unlabeled data set into a predetermined number of clusters using centroid-based clustering calculations;
creating, by the processor, percentile-based references to assign class service names for each of the plurality of cabin class clusters; and
contemporaneously displaying, on a single display, a graphical representation of cabin class mapping for the plurality of airlines based on the percentile-based references.

2. (canceled)

3. The method according to claim 1, wherein the percentile-based references map the RBKD values of each of the plurality of airlines to a cluster value and a corresponding cabin class cluster.

4. The method according to claim 1, wherein the cabin class cluster indicates a cabin class, the cabin class being at least one of a first class, business class, economy class, premium economy class, and discount economy class.

5. The method according to claim 3, wherein the percentile-based references further map airline identifiers to the RBKD values of the plurality of airlines.

6. The method according to claim 1, wherein the fare type variable indicates a fare type.

7. The method according to claim 6, wherein the fare type corresponds to a plurality of RBKD values.

8. The method according to claim 6, wherein the fare type corresponds to a single RBKD value.

9. The method according to claim 1, wherein the fare mapping algorithm utilizes association rules from the raw data gathered.

10. The method according to claim 1, wherein, when the airline data participation of an airline among the plurality of airlines is determined to be direct, the one or more data sources includes the airline.

11. The method according to claim 1, wherein the dimensionality reduction is performed using correlation analysis.

12. The method according to claim 11, wherein the dimensionality reduction is further performed based on at least one of a factor analysis, correlation analysis, and feature importance ratio technique.

13. (canceled)

14. The method according to claim 1, wherein the raw data gathered includes at least a carrier number, the RBKD values, total ticketing amount, average fare, and average tax amount.

15. The method according to claim 1, wherein the raw data includes data elements listed on an airline ticket.

16. The method according to claim 1, wherein the RBKD values are included in fare basis codes.

17. The method according to claim 1, wherein the cabin class mapping is displayed as a color-coded graph in the graphical representation.

18. The method according to claim 17, wherein each ticket is displayed as a node of a particular color corresponding to a respective cabin class.

19. A system for providing an airline agnostic dynamic cabin mapping, the system comprising:
a memory;
a display; and
a processor,
wherein the system is configured to perform:
gathering raw data from one or more data sources for capturing reservation booking designator (RBKD) values for a plurality of airlines, wherein each of the plurality of airlines utilize a different mechanism for designating a plurality of cabin classes;
determining airline data participation for each of the plurality of airlines, wherein the airline data participation is direct or indirect;
executing a fare mapping algorithm for generating a fare type variable based on the raw data gathered;
compiling the raw data gathered and the fare type variable for generating unlabeled data set
performing dimensionality reduction on the unlabeled data set for generating a set of input variables to input to a machine learning (ML) model, wherein the ML model is an unsupervised K-means clustering algorithm model that calculates a distance between each data point and a centroid to assign a cabin cluster and assigns each data point to the nearest centroid;
creating a first training set comprising a mapping between the RKBD values and the cabin class clusters;
first training the ML model in a first stage using the first training set;
creating a second training set comprising the first training set and a portion of the mapping between the RKBD values and the cabin class clusters that are incorrectly determined after the first stage of training;
second training the first trained ML model in a second stage using the second training set;
executing the second trained ML model for generating a plurality of cabin class clusters by inputting the set of input variables and partitioning the unlabeled data set into a predetermined number of clusters using centroid-based clustering calculations;
creating percentile-based references to assign class service names for each of the plurality of cabin class clusters; and
contemporaneously displaying, on a single screen of the display, a graphical representation of cabin class mapping for the plurality of airlines based on the percentile-based references.

20. A non-transitory computer readable storage medium that stores a computer program for providing an airline agnostic dynamic cabin mapping, when executed by a processor, causing a system to perform a plurality of processes comprising:
gathering raw data from one or more data sources for capturing reservation booking designator (RBKD) values for a plurality of airlines, wherein each of the plurality of airlines utilize a different mechanism for designating a plurality of cabin classes;
determining airline data participation for each of the plurality of airlines, wherein the airline data participation is direct or indirect;
executing a fare mapping algorithm for generating a fare type variable based on the raw data gathered;
compiling the raw data gathered and the fare type variable for generating unlabeled data set;
performing dimensionality reduction on the unlabeled data set for generating a set of input variables to input to a machine learning (ML) model, wherein the ML model is an unsupervised K-means clustering algorithm model that calculates a distance between each data point and a centroid to assign a cabin cluster and assigns each data point to the nearest centroid;
creating a first training set comprising a mapping between the RKBD values and the cabin class clusters;
first training the ML model in a first stage using the first training set;
creating a second training set comprising the first training set and a portion of the mapping between the RKBD values and the cabin class clusters that are incorrectly determined after the first stage of training;
second training the first trained ML model in a second stage using the second training set;
executing the second trained ML model for generating a plurality of cabin class clusters by inputting the set of input variables and partitioning the unlabeled data set into a predetermined number of clusters using centroid-based clustering calculations;
creating percentile-based references to assign class service names for each of the plurality of cabin class clusters; and
contemporaneously displaying, on a single display, a graphical representation of cabin class mapping for the plurality of airlines based on the percentile-based references.
